(19) United States
(12) Patent Application Publication
(10) Pub. No.: US 2006/0113960 A1
(43) Pub. Date: Jun. 1, 2006

(54) Power management unit for portable electronic equipment

(76) Inventors: Magnus Thulesius, Lund (SE); Stefan Burstrom, Lund (SE)

Correspondence Address: BIRCH STEWART KOLASCH & BIRCH, PO BOX 747, FALLS CHURCH, VA, 22040-0747, US

(21) Appl. No.: 10/541,533

(22) PCT Filed: Jan. 19, 2004
(86) PCT No.: PCT/SE04/00061

§ 371 Date: Jul. 8, 2005

Related U.S. Application Data
(60) Provisional application No. 60/440,607, filed on Jan. 17, 2003.

(30) Foreign Application Priority Data
Jan. 17, 2003 (SE) 0300110-4

(51) Int. Cl. H02J 7/00

(52) U.S. Cl. 320/133

(57) ABSTRACT

A power management unit (40) for a portable electronic apparatus is disclosed. The apparatus is powered by at least a battery (42), and the power management unit is implemented as an integrated circuit. The power management unit (40) may comprise a general purpose analog-to-digital converter block (57) comprising a first switch for selecting one of at least two analog input signals, and an analog-to-digital converter which is arranged to convert said selected analog input signal into a digital signal; an analog event generator block (52), which is arranged to provide an indication for controlling an operating state of said power management unit when an analog input signal assumes a predetermined relation to a predetermined reference value; a timer block (54), which is operable for providing a timing signal independently of which one of a plurality of operating states the power management unit is operable in; and/or a battery charge control block (53), which is capable of controlling a battery charge current based on an estimated charge power. Also disclosed is an electronic pen comprising the power management unit.

### TECHNICAL FIELD

The present invention relates to a power management unit for use in a portable device, such as an electronic pen, which is powered by at least a battery, the power management unit being implemented as an integrated circuit. More specifically, the invention relates to an improved power management unit.

### TECHNICAL BACKGROUND

Electronic pens are a relatively new product category comprising pens that have the capability of recording a digital copy of information that is written down by means of the pen.

A specific type of such electronic pens was developed by the present applicant. This particular type of electronic pens uses a digital camera to record digital images of a base on which hand-written information is jotted down by means of the pen. The base is provided with a position coding pattern, which is recorded on the digital images. From each electronic image, the electronic pen is capable of determining a position based on the position coding pattern. By recording a series of digital images while a user is writing information on the base, the electronic pen is able to derive a series of pairs of coordinates, which e.g. represent each individual pen stroke.

The electronic pen typically comprises a data processing device, a digital image sensor, a memory, a communication interface, sensors, such as a force sensor for detecting when the pen is used, a user interface, typically one or more LEDs, an acoustic transducer and/or a vibrator and a power supply, typically a battery, which may be rechargeable.

Like all other portable devices that utilize a battery as a power source, and that comprise components that are sensitive to cross-talk, efficient power management is important.

Thus, many portable devices are provided with a power management unit, which typically is an integrated circuit having power management functionality. Such power management functionality may comprise power regulation and supply blocks for different components; input power selection (mains/battery) blocks; battery charging control blocks; power-on/power-off control blocks and interface blocks, such as e.g. I2C BUS®, which is provided by Philips Electronics N.V. Corp., Netherlands, and which is suitable for communication with e.g. a data processing device.

U.S. Pat. No. 6,348,744 B1 discloses a power management unit for use in cellular telephone terminals. This power management unit comprises self test functionality; power-up functionality, which e.g. allows the components of the cellular telephone terminal to be powered-up in a predetermined sequence, and a logic array which allows for communication with and control by a data processing device.

However, there is a need for an improved power management unit, which at a low cost and small physical dimensions enables extended battery life, improved monitoring and control functions, which is compatible with a number of different wall chargers and battery types, and which minimizes the number of additional components needed for efficient power management.

### SUMMARY OF THE INVENTION

An object of the present invention is to provide an improved power management unit for a portable electronic apparatus. The object is wholly or partially accomplished by a power management unit according to any one of the independent claims. Preferred embodiments of are set forth in the dependent claims and in the following description, which is to be read together with the drawings.

According to a first aspect of the invention, there is provided a power management unit for a portable electronic apparatus, which is powered by at least a battery, the power management unit being implemented as an integrated circuit. The power management unit comprises at least one of:

a general purpose analog-to-digital converter block comprising a first switch for selecting one of at least two analog input signals, and an analog-to-digital converter which is arranged to convert said selected analog input signal into a digital signal;

an analog event generator block, which is arranged to provide an indication for controlling an operating state of said power management unit when a third analog input signal assumes a predetermined relation to a predetermined reference value;

a timer block, which is operable for providing a timing signal independently of which one of a plurality of operating states the power management unit is operable in; and

a battery charge control block, which is capable of controlling a battery charge current based on an estimated charge power.

This arrangement provides efficient monitoring functions for the power management unit.

A power management unit, hereinafter referred to as a “PMU”, typically comprises a control block having a power-on-reset function and one or more voltage regulators for providing power supply to different units within the electronic apparatus.

The electronic apparatus may be operated by at least a battery, which may be internal or external to the electronic apparatus. Optionally, the electronic apparatus may comprise a DC input, i.e. a generally transformed and rectified mains power supply. Also, the electronic apparatus may comprise a charger for charging the battery, e.g. by means of the DC input.

Typically, all blocks of the PMU are provided in one integrated circuit.

The at least two analog input signals may represent a temperature, a force, a pressure, a battery charge current, a battery voltage or an input voltage. Hence, a temperature sensor, a force sensor or a pressure sensor may be connected directly to the power management unit for enabling the power management unit to directly control the power supply of the electronic apparatus based on ambient conditions at the respective sensor. The pressure sensor may e.g. be used to detect whether the pen's writing tip is in contact with the base on which information is to be written down. Optionally any resistive or capacitive sensor may be used to detect changes in the ambient conditions of the device or of the power management unit. One such example is where a capacitive sensor is used to detect that a user has grasped the pen, possibly in a manner which may indicate that use of the pen is imminent. Similarly, the power management unit may monitor and/or control the power supply based on battery status and/or input voltage.

An arrangement with an event registration provided by the analog event generator block enables control of the PMU based on its physical environment. The events registered by the PMU may be indicated to the control block and optionally to other blocks as well, such as to the general purpose analog-to-digital converter block. The indication may comprise a trigger signal for the respective block, or it may be provided by means of a code in the register bank in the control block, which in its turn is read by the respective block.

A trigger signal may be a digital signal indicating to a control block that a certain event has taken place. A trigger signal may also be provided based on an analog input signal which is being monitored and compared with a predetermined reference value. Thus, the trigger signal may be generated when the monitored signal exceeds or falls below the predetermined reference value for a predetermined amount of time. Alternatively, the trigger signal may be generated as a result of the monitored signal exceeding or falling below a certain value for a predetermined amount of time.

Based on the indication, the control block may generate an interrupt signal indicating to an external unit that a certain event has taken place. The interrupt signal may cause a control block and/or the external unit to shift from a first of said plurality of operating states to a second of said plurality of operating states.

Interrupt signals generated to the external unit are generated using several individual channels. The selection of which interrupt that uses which channel can be made arbitrarily by the external unit. This allows the external unit to give the interrupts different priorities. E.g. an interrupt signal relating to a voltage level may be of less importance than the an interrupt signal relating to the pen tip.

By the arrangement with the timer block, a power efficient PMU is provided, which may be awaken by a time signal. By “independently” is meant that the timer block provides the timing signal independently of whether the power management unit is in an active or passive state. Thus, the power management unit is capable of keeping track of time, even when the rest of the electronic apparatus is turned off. This significantly reduces the apparatus' power consumption.

The general purpose analog-to-digital converter block may comprise task list means, indicative of a sequence in which said at least two analog input signals are to be processed by said analog-to-digital converter, whereby said first switch is controlled according to said task list means. Such a task list may be a list, i.e. a digital representation, comprising e.g. a channel indication (for indicating which analog input signal should be converted). Optionally, the task list may comprise an averaging value, which is indicative of an amount of time or samples during which the conversion should take place. The task list may be either a fixed (predetermined) or a programmable list.

The task list means may be programmable for providing a desired sequence in which said at least two analog input signals are to be processed by said analog-to-digital converter. By “programmable” is meant that the list may be controlled in an arbitrary manner, e.g. by means of register settings, which may be provided by the control block of the power management unit or by an external unit of an apparatus in which the power management unit is used, such as a processing unit.

The general purpose analog-to-digital converter block may comprise averaging means for providing an average of said digital signal. The averaging means may be arranged to provide an averaged digital signal, in order to eliminate e.g. noise.

The general purpose analog-to-digital converter block may comprise storage means for storing said digital signal or said average of said digital signal. The storage means may e.g. be provided in the form of memory cells, or in the form of register entries, where the output values from the analog-to-digital converter may be retrieved by e.g. the control block or by an external unit. In one embodiment, the values stored in the storage means are regularly updated, e.g. as a consequence of controlling the general purpose analog-to-digital converter according to the task list means.

The general purpose analog-to-digital converter block may comprise a second switch for selecting one of at least two storage areas in said storage means, in which said average of said digital signal is to be stored. The second switch is arranged for controlling where the output from the general purpose analog-to-digital converter is relayed.

The general purpose analog-to-digital converter block may comprise means for receiving a measurement request, comprising an indication of a prioritized one of said at least two analog input signals, and means for controlling said first switch such as to bypass said task list means. A measurement request may be an ad-hoc request generated by e.g. the control block (e.g. in response to a signal indicating an event), an external unit or by test equipment in connection with manufacturing or service of the power management unit. Upon receipt of a measurement request, the general purpose analog-to-digital converter may be configured to finish the current task in the task list means, and to perform the requested measurement prior to returning to the next entry in the task list means.

The power management unit may be arranged for receiving said measurement request from an external unit. The external unit may be a circuit outside the power management unit, such as a processing unit or test equipment for testing in connection with manufacturing. In one embodiment, at least one of said first and said second switch comprises a multiplexer or a de-multiplexer, respectively.

The third analog input signal may represent a temperature, a pressure, a battery charge current, a battery voltage or an input voltage. Hence, the ambient temperature or pressure may trigger the power management unit to shift operating states. Specifically, a pressure sensor may be arranged to sense when the electronic apparatus is applied to a base, whereby the electronic apparatus may be activated. The power management unit may also be e.g. activated in response to a change in the power supply of the electronic apparatus. In addition, the control block may trigger e.g. self tests or send status reports to an external unit based on the indication.

The analog event generator block may comprise an analog signal input, a reference signal input and a comparator for comparing said third analog input signal and said reference signal, whereby the indication is provided based on the comparison.

The analog event generator block may comprise delay means for eliminating rapid changes of the output signal providing the indication. The delay means may require the output signal from the comparator to remain stable for a certain period of time prior to the indication being generated. Alternatively, the delay means may provide a running average of the comparator output.

The analog event generator block may be arranged for receiving said predetermined reference value in digital form, to convert said reference value into an analog form, which is provided said comparator. By receiving the reference signal in digital form, it is possible to alter the reference value by supplying a new reference value.

The power management unit may be arranged to shift from an essentially passive operating state into an essentially active operating state based on the indication. An essentially passive operating state may be e.g. an off state or a standby or sleep state, while an essentially active state may be e.g. an on state or a state where one or more units of the electronic apparatus are receiving a power supply and are thus active. The exact definition of the passive and active states by necessity varies according to the specific product in which the power management unit is used. The power management unit may be arranged to at least partially power up the portable electronic apparatus based on the indication.

The timer block may be arranged to provide a time indication based on said timing signal. A time indication may be a real time indication (such as hours, minutes and seconds), but it may also be a date.

The timer block may be arranged to provide an alarm signal when said time indication coincides with a predetermined time. The predetermined time may be a time (hours/minutes/seconds) and/or a date (year/month/day).

The power management unit may be arranged to shift, in response to said alarm signal, from a first of said plurality of operating states to a second of said plurality of operating states.

The timer block may comprise an oscillator for providing said timing signal. According to one embodiment, the timer block of the power management unit comprises an oscillator for providing the timing signal. In this case, only the timer block of the power management unit needs to be in an active state of operation, while the rest of the power management unit and the electronic apparatus may be in a passive state of operation.

The timer block may alternatively be arranged to receive an oscillator signal from an external unit, whereby the timing signal is based on said oscillator signal. According to this embodiment, the electronic apparatus is provided with a separate oscillator for providing a timing signal to the timer block of the power management unit.

In the battery charge control block, the estimated charge power may be determined based on an measured charge current and on a measured charge voltage. The measured charge current and the measured charge voltage may be provided to a processor. A desired charge current may be indicated by the processor. This arrangement of the battery charge control block provides flexibility with respect to DC power source, since the charger may be controlled such as to limit the heat generated by the components associated with the charging.

Finally, a desired battery voltage may be indicated y the processor. This arrangement also provides flexibility with respect to the choice of battery, since the charging may be controlled by software that is executed in a processor that is external to the PMU.

According to a second aspect of the invention, there is provided an electronic pen, comprising an image sensor for recording a position coding pattern on a base on which information is written down using the electronic pen, and a processor for processing information received from said image sensor. The electronic pen comprises a power management unit according to any one of the preceding claims.

The PMU according to the invention may be implemented in the form of an application specific integrated circuit (ASIC).

### BRIEF DESCRIPTION OF THE DRAWINGS

FIG. 1a is a schematic block diagram of an apparatus comprising a power management unit according to an embodiment of the invention.

FIG. 1b is a schematic block diagram of the power management unit according to an embodiment of the invention.

FIG. 2 is a schematic block diagram illustrating the timer block 54 according to an embodiment of the invention.

FIG. 3 is a schematic block diagram of an analog event generator block 52 according to an embodiment of the invention.

FIG. 4 is a schematic block diagram of a general purpose analog-to-digital converter 57 block according to an embodiment of the invention.

FIG. 5 is a schematic block diagram of a battery charge control block 53 according to an embodiment of the invention.

FIG. 6 is a schematic illustration of an extended test block 58, which may be connected to the general purpose analog-to-digital converter 57.

### DESCRIPTION OF EMBODIMENTS OF THE INVENTION

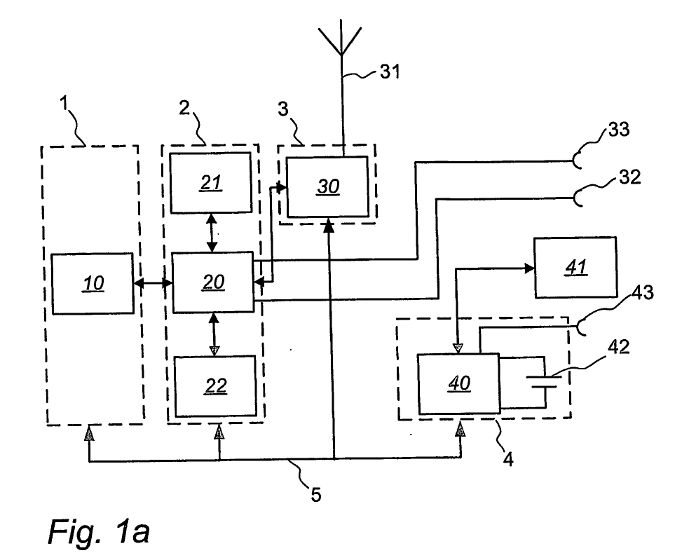

FIG. 1a is a schematic diagram of an electronic apparatus comprising a power management unit. The description will be made based on the assumption that the apparatus is an electronic pen similar to that described in the prior art context. However, it is noted that the power management unit is also applicable to other portable apparatuses, such as portable communication equipment, e.g. mobile or cellular telephones, personal digital assistants (PDA), portable computers, GPS navigation equipment etc.

The system of FIG. 1a comprises four main sections: an imaging section 1, a processing section 2, a communication section 3 and a power management section 4. The sections are interconnected with each other, as is generally indicated by reference numeral 5.

The imaging section 1 may comprise an image sensor 10, which in the case of electronic pens is arranged to record images of a base on which information is written down. Power for the imaging section 1 is supplied by the power management section 4.

The processing section 2 may comprise a processing unit 20, i.e. a microprocessor or a signal processor, a volatile memory 21, e.g. a RAM and a non-volatile memory 22, e.g. a Flash-memory. It is noted that equivalent or integrated devices may be provided. Power for the processing section 2 is supplied by the power management section 4.

The communication section 3 comprises interface modules for communication with external devices. Such interface modules may be based on e.g. Bluetooth®, IrDA®, USB, RS232, WLAN etc. In the described embodiment, the communication module comprises a Bluetooth®-transceiver 30, which has an antenna element 31. The described embodiment also comprises an IrDA® interface 32 and a USB interface 33, which may be connected directly to the processing unit 20. Power for the communication section 3 is supplied by the power management section 4.

The power management section 4 comprises a power management unit 40, which cooperates with a battery 42 and preferably also with a DC input 43 from a power converter (not shown in Figs). The power management section 4 is also connected to one or more sensors 41, such as a force sensor or a pressure sensor (capacitive or resistive) and/or a temperature sensor. The power management section 4 is arranged to communicate with the processing section 2 via an interface, such as I2C BUS® (hereinafter referred to as I2C) or any similar communication interface.

Referring to FIG. 1b, the description will now focus on the power management unit 40. FIG. 1b is a schematic diagram of a power management unit according to an embodiment of the invention. The power management unit 40 is suitable for implementation in the form of an application specific integrated circuit (ASIC), e.g. using a Fine pitch Ball Grid Array (FBGA) or equivalent.

The power management unit 40 according to the invention comprises a number of functional blocks, which may be combined into a suitable design based on the requirements of the apparatus in which the power management unit 40 is to be used.

The power management unit 40 (PMU) comprises a control block 49, which typically comprises a power-on-reset function for controlling the power-up/down sequence, an event control block (comprising control logic) for handling internal and/or external events, and an I2C interface block for communication with external units such as e.g. the processing unit 20. Finally, the control block 49 may comprise a register bank (not shown in Figs) which may be used to communicate with the different blocks of the PMU 40 and with the processing unit 20 via the I2C interface block. The contents of the register bank in the control block 49 may be affected by events as well as by the different functional blocks constituting the PMU.

The control block may be operable in a plurality of operating states or modes, which are determined based on events, battery voltages and settings provided via e.g. the I2C interface. The control block 49 may also be connected to activation devices 45, such as a power switch or other means that is used to initiate system power-up or power-down. One example with regard to the electronic pen embodiment is where such an activation sensor detects that a protective cap of the pen is removed, which may indicate that a user intends to use the pen shortly.

The PMU may comprise a number of functional blocks 50, 51, 52, 53, 54, 55, 56, 57, which are in communication with the control block 49, and which will be briefly discussed below.

The PMU may comprise a battery charger block 53 which manages charging of the battery or batteries 42 and which communicates with the control block 49.

The PMU may comprise a general purpose analog-to-digital converter (GP ADC) 57, which may convert one or more analog signals, such as sensor signals, battery voltages or currents etc. into digital signals which may be monitored by e.g., the control block 49 or by the processing unit 20 via the I2C interface.

The PMU may comprise one or more analog event generators 52, which based on analog signals relating to events in different parts of the PMU provide indications for shifting the control block's 49 operating state. Furthermore, the analog event generator 52 may send indications to the processing unit 20 via e.g. the control block 49 or via the register bank in the control block 49. The analog event generators may e.g. wake up the system from a low power state. Moreover, the analog event generator 52 may trigger activities in the general purpose analog-to-digital converter 57.

In the following description, only one analog event generator will be referred to, although it is noted that multiple analog event generators may be applied analogously.

The PMU may also comprise a sensor biasing block 56 for providing bias power to one or more sensors 41a, 41b, and for receiving analog sensor signals from the sensors 41a, 41b. The analog sensor signals may be provided to the analog event generator 52 and/or to the GP ADC 57 for conversion.

The PMU may also comprise one or more voltage regulated sources 55 for providing drive power to one or more components 48 or sections 1, 2, 3 of the apparatus. Each source 55 may comprise a separate regulator for providing a specific and filtered power to each component 48. In one embodiment, two or more power supplies may be provided to each component 48, e.g. in order to reduce crosstalk between an analog part and a digital part of the component 48.

The PMU may comprise a driver block 51 for one or more user indicators 46, such as LEDs, vibrators or acoustic transducers. The driver block 51 may comprise a plurality of separate regulators for providing a specific and filtered power supply to each component.

The PMU may comprise an illumination driver 50 for driving e.g. IR-LEDs 44 for illumination of the base, e.g. a paper. Each IR-LED may be individually supplied and its current may be regulated so as to provide no more than sufficient illumination for the image detector to work properly.

The PMU may comprise a real time oscillator 54 for providing a timing signal and for keeping track of time. The oscillator may optionally be connected to an external oscillator 47 for providing a timing signal, which may be divided into one or more suitable clock frequencies for use within the PMU.

In the following, a description of power management unit according to an embodiment of the invention will be given.

The control block 49 including power-on-reset and event control functions (not shown in Figs) may constitute a local controller for the PMU. The power-on-reset function handles system startup by being connected to the switch or switches that are arranged to activate the electronic pen and by being arranged to receive indications of events. Moreover, it may provide the proper startup sequence for different modules, blocks or components within the electronic pen, e.g. so as to reduce startup current surges. Furthermore, the power on reset function may handle the different operating modes or states, that may be assumed by the electronic pen. Operating states may be shifted based on user inputs, or on indications of events that are generated by other blocks in the PMU.

For example, the PMU may be configured to operate in five states depending on battery voltage, internal or external events and settings made by the processing unit 20. A first such state may be an off state, wherein external sections 1, 2, 3 and at least parts of the PMU are turned off. However, during an off state, sensors, in response to which the device may be powered on, may nevertheless be active and thus sufficiently powered to that effect. Also external oscillators may be powered in order to provide a clock frequency for e.g. a timing unit. A second state may be an initial charge state (or trickle charge), which may be activated based on e.g. the connection of a DC supply. A third state may be a stand-by state, wherein certain parts of the PMU and possibly also parts of the device may be activated. A fourth state may be “power-on-request”, during which some or all of the components of the device are powered up, possibly in a predetermined sequence. A fifth state may be an active or on state, wherein the device is fully or at least partially operable.

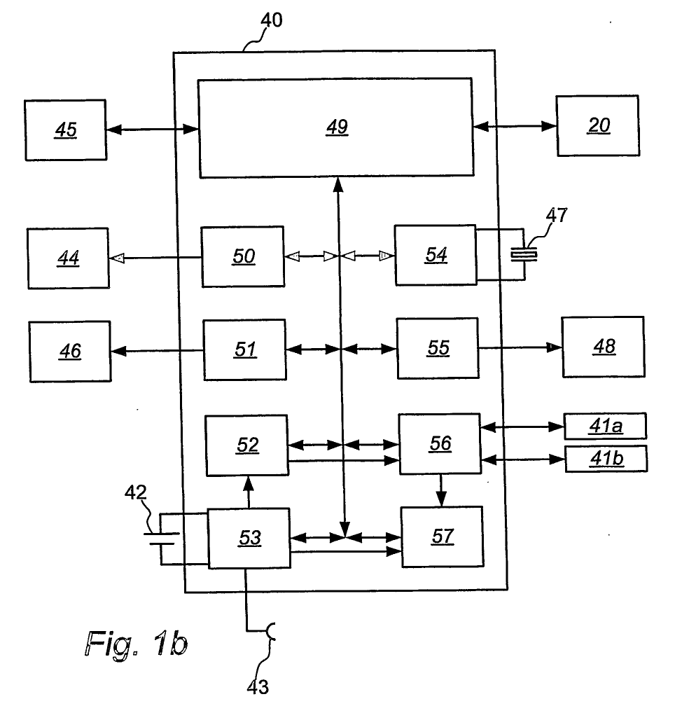

The PMU 40 and its components will now be described in more detail with reference to FIGS. 2-4.

Referring to FIG. 2, the description will now be directed to the timer block 54. FIG. 2 is a block diagram of the timer block according to the described embodiment.

The timer block 54 may comprise a timing logic 541, which may comprise a counter for keeping track of time, one or more alarm settings and a comparator for comparing each alarm setting with the present time. The timer block may further comprise a real time oscillator 542 and optionally a low power oscillator 543. The real time oscillator 542 may provide a timing signal to the timing logic 541 and an output frequency signal Fout. In one embodiment, the real time oscillator 542 has its own crystal providing the oscillating signal, which may be active even though the rest of the power management unit is inactive. Optionally, an external oscillator 47 may be connected for providing a clock frequency to the real time oscillator 542.

The low power oscillator 543 may be arranged to provide a clock frequency for e.g. buck regulators (not shown in Figs), should such be required. The low power oscillator may also supply a clock frequency to the real time oscillator, in which case the real time oscillator may need to divide the frequency provided, since the low power oscillator typically operates at a higher frequency than the real time oscillator.

Thus, the real time oscillator 542 may provide a clock frequency signal based on its own crystal, an external oscillator 47, a system clock (SYS_CLK) in e.g. the processing section 2 or the low power oscillator 543.

The real time oscillator 542 and timing logic 541 keep track of time, both by providing a local clock frequency (Fout) for the operation of the PMU, and by keeping track of real time. Furthermore, the timer block 54 may be provided with alarm functionality for providing an alarm signal, by which an alarm function may be invoked at a user-defined time.

In the described embodiment, the timing logic 541 may have two alarms A1, A2 that can be set via e.g. I2C. After a cold reset (a power source is connected to the device in which the PMU is arranged), initial settings may enable the real time oscillator 542, timing logic 541 and Fout (output frequency). There may be configurations where an external oscillator 47 need not be present. After startup, this can be detected, and the real time oscillator 542 can then be switched OFF. Systems where an external oscillator is not present may need to rely on a more crude timing provided by the low power (LP) oscillator 543.

The LP system oscillator 543 may also be used for configurations where the external oscillator 47 is not present. The real time oscillator may need to detect that the external oscillator 47 is not present and if so, use the system LP oscillator 543 instead.

In one embodiment, the timer block 54, especially the low power oscillator 543, is configured to receive a system clock signal SYS_CLK, which may be received by the LP oscillator 543 as indicated in FIG. 2. During start-up the SYS_CLK may not be present. When the SYS_CLK becomes available, the LP system oscillator 543 may be switched off. Now, a divided SYS_CLK may replace the LP system oscillator. It is also possible to force usage of the LP oscillator 543 by settings in the register bank in the control block 49. Clocking of switching boost and DC/DC converter may now need to be synchronized to the system clock SYS_CLK.

An n second watchdog may provide a signal W for switching off the PMU if it has not been reset. The watchdog timer starts at start-up and is reset for every read of the register bank event register. When the watchdog timer has counted for 87% (div 8) of n seconds, an interrupt may be asserted. The processing section 2 may now need to read the event register to reset the watchdog timer in order to prevent the PMU from powering OFF the system.

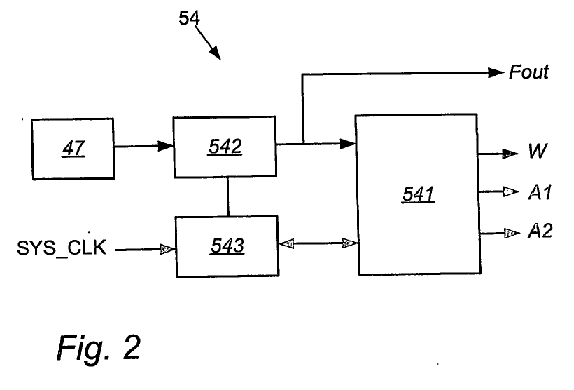

Referring to FIG. 3, a description of the analog event generator block 52 will now be given. FIG. 3 is a block diagram of the analog event generator block. The purpose of the analog event generator block 52 is to evaluate sensor signals and to generate indications of events to the control block 49, for controlling the latter in response to analog events, such as temperature, voltage level, force or charge current.

The analog event generator block 52 is arranged to receive an input signal as indicated in FIG. 3. The input signal may be e.g. a sensor signal from e.g. a force, pressure or temperature sensor. Alternatively, the input signal may be a voltage or current indication relating to e.g. battery voltage, charge voltage, charge current or current drawn by the device. The input signal is supplied to a comparator 522, which also receives a reference value from a reference source 521. The reference source 521 may comprise a digital-to-analog converter (not shown in Figs) for converting a digital reference value (threshold) into an analog value which may be supplied to the comparator 522. The result from the comparator may be supplied as an indication of an event as indicated in FIG. 3. Optionally, the indication of an event may be output via a delay 523 in order to reduce fluctuations, to prevent false indications of events from being triggered and to provide a stable output. Optionally, the analog event generator block may be provided with biasing means 56 for providing bias current to the sensors. It is noted that while only a general description 6f one analog event generator block 52 is given, an arbitrary number of such analog event generator blocks may be included in the PMU, each analog event generator block being adapted to receive a predetermined type of signal.

In the described embodiment, the analog event generator block 52 is connected to a temperature sensor, which may be arranged to sense the temperature inside the device in which the PMU is arranged. Thus, the analog event generator block may be arranged to generate an indication of an event when a predetermined temperature level is reached. This may be used to prevent the device from being damaged due to too high or too low operating temperatures.

In addition, in the case where the device is an electronic pen as described above, the analog event generator block may also be connected to a force sensor, which may be arranged to sense whether the writing tip of the pen is in contact with a base or not. Furthermore, the analog event generator block 52 may be arranged to sense the supply voltage and/or the charge current.

The analog event generator block 52 can be used to set up level triggers for analog signals. As the signal passes a set threshold, the output indication of an event changes state (high/low). Each analog event generator block may consist of a digital to analog (DAC) converter in order to set a threshold with digital representation. The DAC output plus the signal monitored is fed to a comparator. The comparator hysteresis may be small. The comparator output may be digitally filtered. As the comparator output becomes high, the filter makes sure that the signal is high for a set time before the filter output becomes high. As the comparator output becomes low, the filter may again make sure that the signal is stable low for the time set in the filter. Based on the comparator output, a trigger signal may be generated. Alternatively, or in addition to the trigger signal, a register may be updated so as to indicate the event, by e.g. setting a flag or a value in the register.

The DAC, the comparator and the filter can be left on when the PMU switches from on to stand-by mode. For test purposes it may need to be possible to bypass the filter delay, hence a switch 525 may be arranged as indicated in FIG. 3.

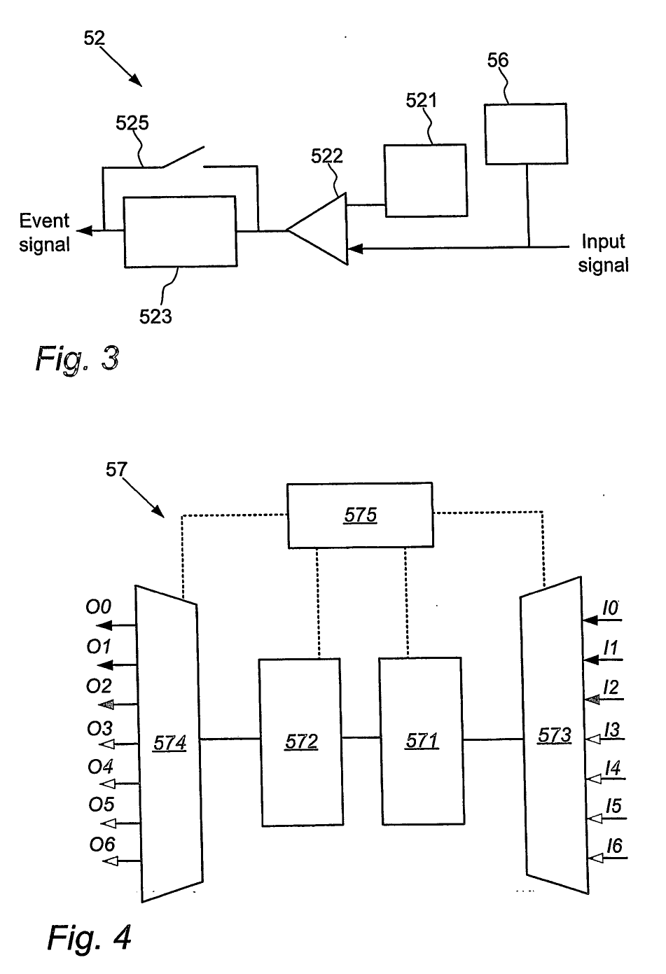

Referring to FIG. 4, a description of the general purpose analog to digital converter 57 (GP ADC) will now be given.

FIG. 4 is a block diagram of the analog to digital converter. The GP ADC block 57 comprises a number of analog sensor inputs, each of which is connected to a respective input I0-I6 of a switch, such as a multiplexer 573. An output from the multiplexer is connected to an analog-to-digital converter (GP ADC) 571, e.g. an 8-bit GP ADC, such that the multiplexer acts as an input selector for the GP ADC. Hence, each multiplexer input I0-I6 represents a channel which is selectable by means of a controller.

The inputs may be connected to e.g. the sensors for temperature, force or pressure. Furthermore, the inputs may be arranged to measure charge current or voltage, battery voltage or current consumption. In addition, one or more inputs may be dedicated for testing of the device, such that an arbitrary analog value may be connected to the input in order to be converted. For the purpose of the description, the inputs may be divided into reserved inputs (meaning those that are reserved for sensors, voltage etc) and general inputs (meaning those inputs that are dedicated for testing).

The output from the GP ADC 571 may be supplied to an accumulator 572, which may operate so as to accumulate an average value of measurements during a predetermined time period or during a predetermined number of samples. In one embodiment, averaging may be made from 4, 16, 64 or 256 samples.

The output from the accumulator 572 may be supplied to a de-multiplexer 574, which at its outputs O0-O6 provides the respective digital output values. In one embodiment, each output value may be supplied to a predetermined area of the register bank in the control block 49. The output value may be stored in a dedicated or general memory, internally in the PMU or in an external circuit. As another alternative, the output value is supplied directly to another block of the PMU, or to an interface for communication with an external unit such as the processing section 2 or test equipment.

Alternatively, the de-multiplexer may be excluded, provided that the output from the accumulator (or directly from the GP ADC) may be supplied directly to a block or unit where it is to be stored or processed.

A controller 575 may be arranged in the GP ADC to maintain a task list, comprising for each task a channel indication and an average setting. The controller 575 controls the operation of the multiplexer 573, the analog-to-digital converter 571, the accumulator 572 and the de-multiplexer 574, as is indicated by the dotted lines in FIG. 4. The channel indication may represent a multiplexer input channel, for receiving a signal, which is to be converted, and the average setting may represent the time period or number of samples during which the output from the GP ADC 571 are to be averaged. Alternatively, an average setting may be associated with each channel, such that the task list only needs to contain the channel indication.

Optionally, the task list may also comprise a range indication for indicating which measurement range is to be used. The length of the task list may be arbitrarily chosen. In one embodiment, the task list may comprise a number of tasks which is equal to the number of reserved inputs. The controller 575 may be arranged so as to control multiplexer and de-multiplexer so that the inputs I0-I6 are processed in the sequence determined by the task list.

The task list may be implemented in e.g. the register bank in the control block 49 or in a separate memory means included in the controller 575.

In one embodiment, the task list is arranged to indicate a fixed sequence according to which the measurements are to be made by the GP ADC 571.

In another embodiment, the task list is arranged to provide a modifiable sequence, which may be altered so as to prioritize a particular input channel. The task list may thus be modifiable or programmable in response to an event that has occurred in the PMU (e.g. as indicated by the analog event generator) or in response to a measurement request from an external unit, such as the processing section 2. Such a measurement request may be received e.g. as a control signal to the controller 575, as a register setting, or in any other known manner.

The controller 575 may thus be arranged to interrupt the sequence provided by the task list, e.g. in response to a measurement request from e.g. the processing section 2 or from external test equipment that is used for diagnosis or testing of the PMU. Measurement requests may also be generated by the control block 49, e.g. in response to event indications. A measurement request may comprise a channel indication and an average setting, or merely a channel indication.

Upon receipt of a measurement request, the controller may add a channel indication that is representative of the sensor to be polled, an average setting that is to be used and optionally a range indication for setting (or shifting) the GP ADC to the correct measuring range for the sensor to be polled. The measured value from the GP ADC may be provided to e.g. the event controller of the control block 49 for further processing or for passing on to the processing unit 20.

As is apparent from FIG. 4, the general purpose analog to digital converter (GP ADC) makes it possible to monitor various variables of interest. The variables of interest, which are typically represented in voltages and currents, may need to be converted into a digital representation, in order to be processable by the PMU 40 or by the processing unit 20. Some variables like the charge current may need to be converted into a voltage prior to their conversion. Some variables may also need a voltage shift.

Analog-to-digital conversion may be started by setting a register in the register bank in the control block 49. In the embodiment with a fixed sequence, the conversion is simply started or stopped by the setting of the flag. In the embodiment with the modifiable sequence, starting the conversion may include selecting a number of samples to take for averaging, plus choosing an indication of a channel of interest. In one embodiment, it may be possible to issue up to four pending tasks (averaging+channel), which may be stored in the GP ADC task list of the controller 575. These tasks may be queued in order to be handled as soon as the present conversion has been completed.

As another alternative, the task list or individual measurement requests may be triggered by events, either as indicated by the analog event generator block 52 or as indicated by the control block 49 in response to an event, or in response to a request from the processing unit 20.

The task list may be either a fixed (predetermined) or a programmable list. The task list may e.g. be implemented in the register bank of the control block 49, in a separate memory or in a memory circuit that is integrated with the controller 575.

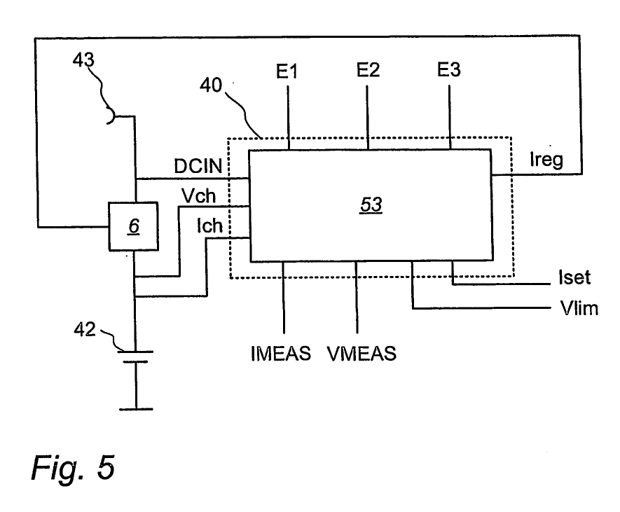

Referring to FIG. 5, the description will now be directed to the battery charger block 53. The battery charger block 53 is the PMU's interface towards the power sources, such as the battery 42 and/or charger (not shown in Figs).

In the described embodiment, the battery charge control block 53 is arranged inside the PMU 40, while a DC power source 43, a battery 42 and a charge current regulator 6 for regulating the charge current are all arranged outside the PMU. The PMU receives an input current DCIN from the DC power source 43, which may be e.g. a wall charger or a DC current from a USB bus. Furthermore, the charge control block 53 may receive a charge voltage input signal Vch at a battery node and a charge current input signal Ich from e.g. the charge current regulator 6, indicating the charge voltage and current, respectively. It is realized that while in FIG. 5, the signals Vch and Ich are indicated as connected to the battery 42 and to the charge current regulator 6, respectively, these signals may be provided in any known manner. The charge voltage Vch and current Ich signals may be forwarded to e.g. the GP ADC as is indicated by signals VMEAS and IMEAS, respectively, so as to enable them to be converted into digital values. Also, by supplying VMEAS and/or IMEAS to the analog event generator block 52, event indications based on these parameters may be provided, e.g. in order to trigger the task list of the GP ADC 57.

The battery charge control block 53 may be arranged to regulate the charge current provided by the charge current regulator 6 in known fashion by means of a signal Ireg, which is supplied to the charge current regulator 6.

The charge current to be provided to the battery may be controlled from within the PMU or from an external unit, such as from the processing section 2. In the described embodiment, a signal Iset indicating a desired charge current may be provided to the battery charge control block 53 as an analog or digital value, which may be set in the register bank of the control block 49. Thus, the charge current may be controlled by e.g. the processing section 2. Alternatively, a reference charge current may be provided in a fashion similar to that in the analog event generator 52 described above.

A battery voltage limit signal Vlim may be provided in a manner similar to that of the signal Iset for the charge current. This may be desirable when there is an upper voltage limit associated with the battery.

The battery charge control block 53 may also be arranged to provide trigger signals E1, E2, E3, indicating that certain events have taken place. Examples of such events may be that an excessive current has occurred, that a DC power source has been connected or that the battery requires initial charging, i.e. the battery voltage is so low that it is not capable of driving the device in which it is arranged.

The charge control block 53 may be used with different types of batteries, requiring different charge currents and voltages, since the signals representing the charge current Iset and the upper voltage limit Vlim may be set by software to an arbitrary value (within the limits of the hardware).

The charge control block 53 may be used with different types of DC power sources, such as wall adapters, since it is capable of being controlled based on the charge current and charge voltage. Based on the charge current and charge voltage, the power (i.e. heat) developed by the components associated with the charging may be estimated. The power may be controlled based on this estimate, by regulating the charge current via Ireg. Thus, damage to other components may be prevented, by limiting the heat development from the components associated with the charging.

The charge control block 53 enables a major part of this control to be handled by the processing section 2, since the signals indicating charge voltage Vch and charge current Ich may be converted into digital values by the GP ADC 57 and then provided to the processing section 2, and since the processing section 2 is capable of controlling the charge current via the signal Iset.

Thus, the adaptation of the PMU to a certain, desired battery and DC power source can be done via software that is executed in the processing section 2.

Thus, the battery charge control block 53 described above provides flexibility with respect to the choice of battery and DC power supply source, thus enabling the device to be easily adapted to different manufacturers equipment.

It is noted that the above described blocks may be combined within the scope of the appended claims, in order to provide a power management unit having a functionality that is appropriate for the intended application. It should further be noted that, whereas the invention has been described in terms of an exemplifying embodiment, it is possible to provide variations within the scope of the appended claims.

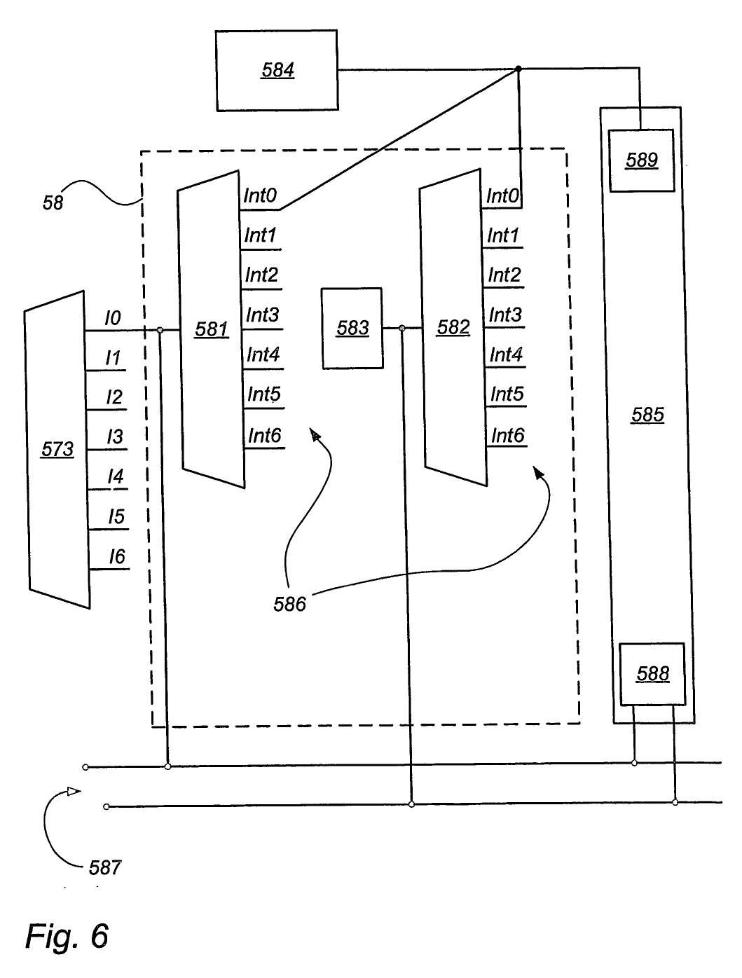

FIG. 6 is a schematic illustration of an extended test block 58, which may be connected to an input 10 of the multiplexer 573 of the GP ADC 57.

In FIG. 6, a first test multiplexer 581 is connected to one of the inputs I0-I6 of the multiplexer 573 of the GP ADC 57. For clarity, only the multiplexer 573 of the GP ADC 57 is illustrated in FIG. 6. The inputs 586 of the first test multiplexer 581 are connected to respective internal test points, such that the first test multiplexer 581 may select any internal test point for testing, thereby allowing these internal test points to be tested using the internal GP ADC 57. As is evident from FIG. 6, an internal test point, which is selected for testing by the first multiplexer 581, may also be tested by external test equipment (sensing and/or loading) via test pads (not shown) connected to an analogue test bus 587.

In FIG. 6, a second test multiplexer 582 is connected to a load function 583, such that an input 586 of the second test multiplexer may be subjected to an arbitrary load, such as e.g. a resistive load or, a current source or a voltage source. In one embodiment, the respective inputs 586 of the first and second test multiplexers are connected to the same internal test points, i.e. input Int0 of the first test multiplexer 581 is connected to the same test point as input Int0 of the second test multiplexer etc. Through this arrangement, it is possible to use the first test multiplexer 581 for testing (sensing) a test point, while that test point, or any other test point, is subjected to a load by the second test multiplexer 582.

In FIG. 6, a test point connected to the input Int0 of the respective test multiplexer 581, 582 may be related to an arbitrary internal function 584 of the PMU 40. FIG. 6 also illustrates that the test point connected to the input Int0 of the respective test multiplexer 581, 582 may be related to an arbitrary function 589 of an external circuit 585. This external circuit 585 may be another circuit within the apparatus in which the PMU 40 is arranged, or even a circuit arranged in a device which is external and connected to the apparatus in which the PMU 40 is arranged.

As illustrated in FIG. 6, it is also possible to provide an analog test bus 587, through which a test block 588 (comprising a test multiplexers 581 and optionally a second test multiplexer 582 and the load function 583) similar to that illustrated in FIG. 6, arranged in the external circuit 585 may be connected to the GP ADC 57 of the PMU 40. By this arrangement, it is possible to perform analog self tests in circuits that are external to the PMU 40, in an manner similar to that by which the internal self tests described above with reference to FIG. 6 are performed. Hence, a self test interface is provided, which is expandable to multiple circuits. During testing, the circuits may be controlled by an interface, such as I2C.

The arrangement described with reference to FIG. 6 enables a reduction in the number of physical test points provided in the apparatus where the PMU 40 is used. It also enables testing of internal or external test points while subjected to a load, as well as testing of interconnect between circuits while subjected to a load. The analogue test bus allows a plurality of circuits to share a common test interface. Finally, the apparatus may test itself through the controller and the GP ADC 57 of the PMU 40.

1. A power management unit (40) for a portable electronic apparatus, which is powered by at least a battery (42), the power management unit being implemented as an integrated circuit, characterized in that the power management unit comprises at least one of:
a general purpose analog-to-digital converter block (57) comprising a first switch (573) for selecting one of at least two analog input signals, and an analog-to-digital converter (571) which is arranged to convert said selected analog input signal into a digital signal;
an analog event generator block (52), which is arranged to provide an indication for controlling an operating state of said power management unit when a third analog input signal assumes a predetermined relation to a predetermined reference value;
a timer block (54), which is operable for providing a timing signal independently of which one of a plurality of operating states the power management unit is operable in; and
a battery charge control block (53), which is capable of controlling a battery charge current based on an estimated charge power.

2. The power management unit as claimed in claim 1, characterized in that the power management unit comprises said general purpose analog-to-digital converter block (57), wherein one of said at least two analog input signals represents a temperature, a force, a pressure, a battery charge current, a battery voltage or an input voltage.

3. The power management unit as claimed in claim 1 or 2, characterized in that the power management unit comprises said general purpose analog-to-digital converter block (57), wherein the general purpose analog-to-digital converter block comprises task list means, indicative of a sequence in which said at least two analog input signals are to be processed by said analog-to-digital converter, whereby said first switch is controlled according to said task list means.

4. The power management unit as claimed in claim 3, characterized in that said task list means is programmable for providing a desired sequence in which said at least two analog input signals are to be processed by said analog-to-digital converter.

5. The power management unit as claimed in any one of the preceding claims, characterized in that the power management unit comprises said general purpose analog-to-digital converter block (57), wherein the general purpose analog-to-digital converter block comprises averaging means (572) for providing an average of said digital signal.

6. The power management unit as claimed in any one of the preceding claims, characterized in that the power management unit comprises said general purpose analog-to-digital converter block (57), wherein the general purpose analog-to-digital converter block comprises storage means for storing said digital signal or said average of said digital signal.

7. The power management unit as claimed in claim 6, characterized in that the general purpose analog-to-digital converter block comprises a second switch (574) for selecting one of at least two storage areas in said storage means, in which said average of said digital signal is to be stored.

8. The power management unit as claimed in any one of the preceding claims, characterized in that the power management unit comprises said general purpose analog-to-digital converter block (57), wherein the general purpose analog-to-digital converter block comprises means (575) for receiving a measurement request, comprising an indication of a prioritized one of said at least two analog input signals, and means for controlling said first switch such as to bypass said task list means.

9. The power management unit as claimed in claim 8, characterized in that the power management unit is arranged for receiving said measurement request from a processor (20).

10. The power management unit as claimed in any one of the preceding claims, characterized in that the power management unit comprises said general purpose analog-to-digital converter block (57), wherein at least one of said first and said second switch comprises a multiplexer (573) or a de-multiplexer, respectively (574).

11. The power management unit as claimed in any one of the preceding claims, characterized in that the power management unit comprises said analog event generator block (52), wherein said indication causes a control block (49) to shift from a first of said plurality of operating states to a second of said plurality of operating states.

12. The power management unit as claimed in claim 11, characterized in that said third analog input signal represents a temperature, a force, a pressure, a battery charge current, a battery voltage or an input voltage.

13. The power management unit as claimed in claim 11 or 12, characterized in that the analog event generator block comprises an analog signal input, a reference signal input and a comparator (522) for comparing said third analog signal and said reference signal, whereby said indication is provided based on said comparison.

14. The power management unit as claimed in claim 13, characterized in that the analog event generator block comprises delay means (523) for eliminating rapid changes of said an output signal providing said indication.

15. The power management unit as claimed in claim 13, characterized in that the analog event generator block is arranged for receiving said predetermined reference value in digital form, to convert said reference value into an analog form, which is provided said comparator (522).

16. The power management unit as claimed in any one of claims 11-15, characterized in that the power management unit is arranged to shift from an essentially passive operating state into an essentially active operating state based on said indication.

17. The power management unit as claimed in any one of claims 11-16, characterized in that the power management unit is arranged to at least partially power up the portable electronic apparatus based on said indication.

18. The power management unit as claimed in any one of the preceding claims, characterized in that the power management unit comprises said timer block (54), wherein the timer block is arranged to provide a time indication based on said timing signal.

19. The power management unit as claimed in claim 18, characterized in that the timer block is arranged to provide an alarm signal when said time indication coincides with a predetermined time.

20. The power management unit as claimed in claim 18 or 19, characterized in that the power management unit is arranged to shift, in response to said alarm signal, from a first of said plurality of operating states to a second of said plurality of operating states.

21. The power management unit as claimed in any one of claims 18-20, characterized in that the timer block comprises an oscillator (542, 543) for providing said timing signal.

22. The power management unit as claimed in any one of claims 18-20, characterized in that the timer block is arranged to receive an oscillator signal from an external unit (47), whereby the timing signal is based on said oscillator signal.

23. The power management unit as claimed in claim 1, characterized in that the power management unit comprises said battery charge control block (53), wherein said measured charge power is determined based on the estimated charge current and on the measured charge voltage.

24. The power management unit as claimed in claim 23, characterized in that the power management unit comprises said battery charge control block (53), wherein said measured charge current and said measured charge voltage are provided to a processor (20).

25. The power management unit as claimed in claim 24, characterized in that the power management unit comprises said battery charge control block (53), wherein a desired charge current is indicated by said processor (20).

26. The power management unit as claimed in any one of claims 23-25, characterized in that the power management unit comprises said battery charge control block (53), wherein a desired battery voltage is indicated by said processor (20).

27. An electronic pen, comprising an image sensor (10) for recording a position coding pattern on a base on which information is written down using the electronic pen, and a processor (20) for processing information received from said image sensor, characterized in that the electronic pen comprises a power management unit (40) according to any one of the preceding claims.

28. The power management unit as claimed in claim 1, characterized by a test block (58) comprising a second test multiplexer (582), which is arranged for subjecting one of a plurality of test points (586) to a load, and a first test multiplexer (581) which is arranged for selecting one of said plurality of test points (586) and for providing an analog test signal from said selected test point to said general purpose analog-to-digital converter (57).

29. The power management unit as claimed in claim 28, characterized in that said one of said plurality of test points (586) which is subjected to said load is identical to said one of said plurality of test points which is selected by said first test multiplexer (581).
